(19) United States
(12) Patent Application Publication
(10) Pub. No.: US 2009/0278745 A1
(43) Pub. Date: Nov. 12, 2009

(54) DUAL-BAND INVERTED-F ANTENNA

(75) Inventor: Li-Ju HUANG, Fongshan City (TW)

Correspondence Address: Workman Nydegger;1000 Eagle Gate Tower, 60 East South Temple, Salt Lake City, UT, 84111, US

(73) Assignee: Smart Approach CO., LTD., Hsinchu (TW)

(21) Appl. No.: 12/118,331

(22) Filed: May 9, 2008

(51) Int. Cl. H01Q 9/04

(52) U.S. Cl. 343/700 MS

(57) ABSTRACT

A dual-band inverted-F antenna is described. After being fed in by a signal feed-in portion, a first band signal and a second band signal are wirelessly sent from a first radiation portion and a second radiation portion of a radiation element in one aspect, and transmitted to a ground element through a short-circuit pin in another aspect, so as to achieve the dual-band effect. Meanwhile, a bent structure is designed on the short-circuit pin, such that when the short-circuit pin is employed by the dual-band inverted-F antenna to transmit signals, the interference on the signal transmission/reception of the radiation element will be reduced.

### BACKGROUND OF THE INVENTION

1. Field of Invention

The present invention relates to an inverted-F antenna, and more particularly to a dual-band inverted-F antenna.

2. Related Art

Wireless communication technology employing electromagnetic waves to transmit signals does not need connecting wires for communicating with remote devices. Thereby, products applying the wireless communication technology are advantageous in portability, and thus the types thereof are increasingly grow, such as mobile phones and notebook computers. Further, as these products transmit signals through electromagnetic waves, an antenna for transmitting/receiving electromagnetic wave signals has become essential. Currently, an antenna is mainly exposed out of or built in a device. However, the antenna exposed out of a device not only affects the size and appearance of the product, but is also easily bent or fractured under the impact of an external force, so the built-in antenna has become a trend.

FIG. 1 is a schematic view of a conventional inverted-F antenna. The inverted-F antenna 10 has a striped radiation element 1, a sheet-like ground element 2 spaced from and facing the radiation element, and a short-circuit pin 3 and a signal feed-in portion 4 located between the radiation element 1 and the ground element 2. The short-circuit pin 3 connects one end of the radiation element 1 to the ground element 2. The signal feed-in portion 4 is disposed at a central position between two ends of the radiation element 1, for receiving signals fed in through a signal line. When the signal feed-in portion 4 receives a fed-in signal current, the signal current is split to flow in the left and right directions. When the signal current directly flows toward the short-circuit pin 3 from the signal feed-in portion 4, as the current flows in opposite directions through the signal feed-in portion 4 and the short-circuit pin 3, the current on the left path is counteracted without causing any resonance to generate signals. The length L of the right path is equivalent to that of the right side of the signal feed-in portion 4 in the radiation element 1, i.e., approximately a quarter wavelength. Therefore, signals at a specific frequency may be generated and further induced, and an induced signal current is conducted out through the signal feed-in portion 4.

Thereby, the conventional inverted-F antenna 10 can only transmit/receive mono-signals, and fails to meet the current multiplexing requirements.

### SUMMARY OF THE INVENTION

Accordingly, the present invention is directed to a dual-band inverted-F antenna, for solving the above problem that the conventional inverted-F antenna can only transmit/receive mono-signals. Meanwhile, a bent structure is designed on the short-circuit pin, such that when signals are transmitted through the structure of the short-circuit pin, the interference on the radiation element will be reduced.

A dual-band inverted-F antenna including a radiation element, a ground element, a short-circuit pin, and a signal feed-in portion is provided. The radiation element has a first radiation portion and a second radiation portion. The first radiation portion is used for wirelessly transmitting/receiving a first band signal, and the second radiation portion is used for wirelessly transmitting/receiving a second band signal. The ground element is spaced from and faces the radiation element. The short-circuit pin, located between the radiation element and the ground element, has two ends perpendicularly connected to the radiation element and the ground element respectively. The signal feed-in portion has one end perpendicularly connected to the radiation element, and the other end extending toward the ground element.

In the dual-band inverted-F antenna provided by the present invention, a radiation portion extends from the conventional inverted-F antenna, for transmitting/receiving dual-signals, so as to solve the problem that the conventional inverted-F antenna can only transmit/receive mono-signals

Another dual-band inverted-F antenna including a radiation element, a ground element, a bent short-circuit pin, and a signal feed-in portion is also provided. The radiation element has a first radiation portion and a second radiation portion. The first radiation portion is used for wirelessly transmitting/receiving a first band signal, and the second radiation portion is used for wirelessly transmitting/receiving a second band signal. The ground element is spaced from and faces the radiation element. The bent short-circuit pin, located between the radiation element and the ground element, has two ends perpendicularly connected to the radiation element and the ground element respectively, and is formed with a bent structure at the center. The signal feed-in portion has one end together with the bent short-circuit pin perpendicularly connected to the radiation element, and the other end extending toward the ground element.

In the dual-band inverted-F antenna provided by the present invention, besides adding a radiation portion on the conventional inverted-F antenna to achieve the dual-band effect, the design of a bent structure is further adopted. Thereby, at a low frequency, the current flows in opposite directions through the bent structure, so as to reduce the interference on the signal transmission/reception at the radiation end. While at a high frequency, the current flows in the same direction through the bent structure, so as to enhance the radiation effect.

### BRIEF DESCRIPTION OF THE DRAWINGS

The present invention will become more fully understood from the detailed description given herein below for illustration only, and thus are not limitative of the present invention, and wherein:

FIG. 1 is a schematic view of a conventional inverted-F antenna;

FIG. 2 is a schematic view according to a first embodiment of the present invention;

FIG. 3 is a schematic view according to a second embodiment of the present invention;

FIG. 4 is a schematic view according to a third embodiment of the present invention;

FIG. 5 is a schematic view according to a fourth embodiment of the present invention;

FIG. 6 is a diagram of return-loss simulation according to the second embodiment of the present invention;

FIG. 7 is a diagram of current simulation at a low frequency according to the second embodiment of the present invention;

FIG. 8 is a diagram of current simulation at a high frequency according to the second embodiment of the present invention;

FIG. 9 is a measurement diagram of SWR according to the third embodiment of the present invention;

FIG. 10 is a table showing average gains and efficiencies of the dual-band inverted-F antenna measured at low frequencies according to the third embodiment of the present invention;

FIG. 11 is a table showing average gains and efficiencies of the dual-band inverted-F antenna measured at high frequencies according to the third embodiment of the present invention;

FIG. 12 is a measurement diagram of SWR according to the fourth embodiment of the present invention;

FIG. 13 is a table showing average gains and efficiencies of the dual-band inverted-F antenna measured at low frequencies according to the fourth embodiment of the present invention; and

FIG. 14 is a table showing average gains and efficiencies of the dual-band inverted-F antenna measured at high frequencies according to the fourth embodiment of the present invention.

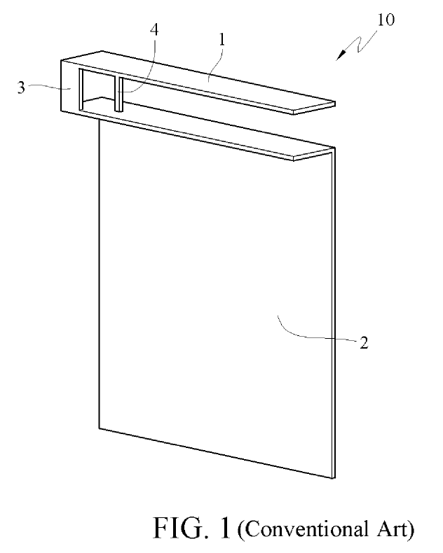

### DETAILED DESCRIPTION OF THE INVENTION

The features and practice of the present invention will be illustrated in detail below with the accompanying drawings.

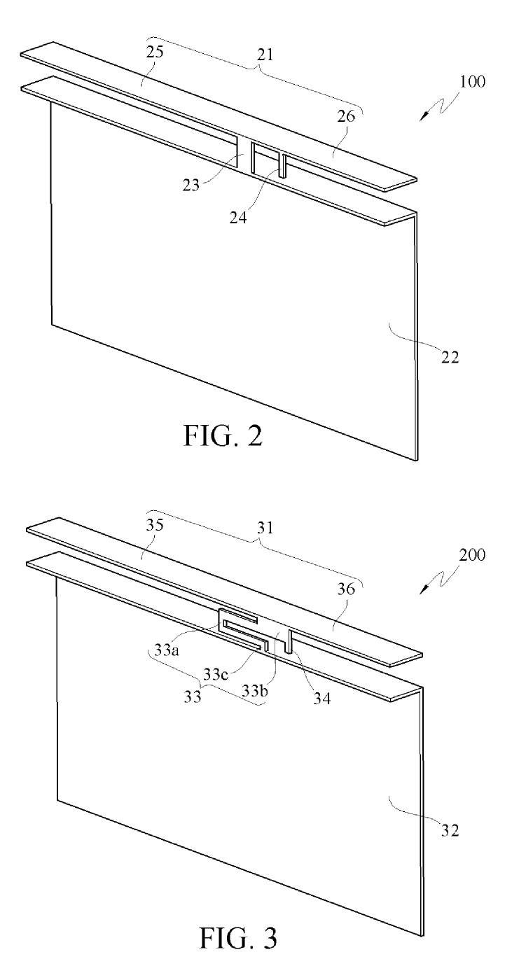

FIG. 2 is a schematic view according to a first embodiment of the present invention. Referring to FIG. 2, a dual-band inverted-F antenna 100 of this embodiment includes a radiation element 21, a ground element 22, a short-circuit pin 23, and a signal feed-in portion 24.

The radiation element 21 has a first radiation portion 25 and a second radiation portion 26. The first radiation portion 25 is used for transmitting/receiving a first band signal, and the second radiation portion 26 is used for transmitting/receiving a second band signal. The radiation element 21 is spaced from and faces the ground element 22. A length of the first radiation portion 25 is approximately a quarter wavelength of the first band signal, or, of course, may be between one-third wavelength and one-fifth wavelength of the first band signal. A length of the second radiation portion 26 is approximately a quarter wavelength of the second band signal, or, of course, may be between one-third wavelength and one-fifth wavelength of the second band signal. The radiation element 21 is in a shape of a flat metal. The first band signal has a frequency band between 824 MHz and 960 MHz, or, of course, other frequency bands. The second band signal has a frequency band between 1710 MHz and 2170 MHz, or, of course, other frequency bands.

The ground element 22 is spaced from and faces the radiation element 21. The ground element 22 is formed by a flat metal spaced from and facing the radiation element 21 and by a rectangular metal plate perpendicularly connected to one side of the flat metal and extending away from the radiation element 21.

The signal feed-in portion 24 has one end perpendicularly connected to the radiation element 21, and the other end extending toward the ground element 22 without contact, for feeding in or out the first band signal and the second band signal. The signal feed-in portion 24 feeds in signals through a signal line, and the signal line includes a signal core, an insulating layer wrapping the signal core, and a ground layer further wrapping the insulating layer. The signal core is connected to the signal feed-in portion 24, and the ground layer is connected to the ground element 22.

The short-circuit pin 23, located between the radiation element 21 and the ground element 22, has two ends connected to the radiation element 21 and the ground element 22 respectively, for transmitting the first band signal and the second band signal from the radiation element 21 to the ground element 22 through the short-circuit pin 23. The short-circuit pin 23 has one end perpendicularly connected to the radiation element 21, and is located with the signal feed-in portion 24 at the same side of the radiation element 21. The short-circuit pin 23 has the other end perpendicularly extending toward the ground element 22 so as to be connected thereto.

According to the dual-band inverted-F antenna 100 of this embodiment, after being fed in by the signal feed-in portion 24, the first band signal and the second band signal are sent from the first radiation portion 25 and the second radiation portion 26 in one aspect, and transmitted to the ground element 22 through the short-circuit pin 23 in another aspect. In the dual-band inverted-F antenna 100 of this embodiment, a radiation portion extends from the radiation element 1 of the conventional inverted-F antenna 10, for transmitting/receiving dual-signals, so as to solve the problem that the conventional inverted-F antenna 10 can only transmit/receive mono-signals.

FIG. 3 is a schematic view according to a second embodiment of the present invention. Referring to FIG. 3, a dual-band inverted-F antenna 200 of this embodiment includes a radiation element 31, a ground element 32, a bent short-circuit pin 33, and a signal feed-in portion 34.

The radiation element 31 has a first radiation portion 35 and a second radiation portion 36. The first radiation portion 35 is used for wirelessly transmitting/receiving a first band signal, and the second radiation portion 36 is used for transmitting/receiving a second band signal. The radiation element 31 is spaced from and faces the ground element 32. A length of the first radiation portion 35 is approximately a quarter wavelength of the first band signal, or, of course, may be between one-third wavelength and one-fifth wavelength of the first band signal. A length of the second radiation portion 36 is approximately a quarter wavelength of the second band signal, or, of course, may be between one-third wavelength and one-fifth wavelength of the second band signal. The radiation element 31 is in a shape of a flat metal. The first band signal has a frequency band between 824 MHz and 960 MHz, or, of course, other frequency bands. The second band signal has a frequency band between 1710 MHz and 2170 MHz, or, of course, other frequency bands.

The ground element 32 is spaced from and faces the radiation element 31. The ground element 32 is formed by a flat metal spaced from and facing the radiation element 31 and by a rectangular metal plate perpendicularly connected to one side of the flat metal and extending away from the radiation element 31.

The bent short-circuit pin 33, located between the radiation element 31 and the ground element 32, has two ends perpendicularly connected to the radiation element 31 and the ground element 32 respectively, and is formed with a bent structure 33a at the center. The bent short-circuit pin 33 includes a first arm 33b, a second arm 33c, and the bent structure 33a. The first arm 33b has one end perpendicularly connected to the radiation element 31 and the other end extending toward the ground element 31 so as to be connected to one end of the bent structure 33a. The second arm 33c has one end perpendicularly connected to the ground element 32 and the other end extending toward the radiation element 31 so as to be connected to the other end of the bent structure 33a. The bent structure 33a is in a “ [symbol] ” shape or a horseshoe shape, and, of course, may be in other shapes. The bent structure 33a is in the same direction as the first radiation portion 35 or in the same direction as the second radiation portion 36.

The signal feed-in portion 34 has one end together with the bent short-circuit pin 33 perpendicularly connected to the radiation element 31, and the other end extending toward the ground element 32 without contact. The signal feed-in portion 34 is used for feeding in or out the first band signal and the second band signal. The signal feed-in portion 34 feeds in signals through a signal line, and the signal line includes a signal core, an insulating layer wrapping the signal core, and a ground layer further wrapping the insulating layer. The signal core is connected to the signal feed-in portion 34, and the ground layer is connected to the ground element 32.

According to the dual-band inverted-F antenna 200 of this embodiment, after being fed in by the signal feed-in portion 34, the first band signal and the second band signal are sent from the first radiation portion 35 and the second radiation portion 36 in one aspect, and transmitted to the ground element 32 through the bent short-circuit pin 33 in another aspect. In the dual-band inverted-F antenna 100 of the first embodiment, when radiated, the signals are fed in by the signal feed-in portion 24 and transmitted to the ground element 22 through the short-circuit pin 23, so the current flowing through the short-circuit pin 23 may directly interfere the radiation element. However, in the dual-band inverted-F antenna 200 of this embodiment, a bent structure 33a is designed on the short-circuit pin 23 of the dual-band inverted-F antenna 100 in the first embodiment. Thereby, when a low-frequency signal is fed in by the signal feed-in portion 34 and transmitted to the ground element 32 through the bent short-circuit pin 33, the signal transmission current flows in opposite directions through the bent structure 33a and is counteracted, so as to reduce the interference on the radiation end. When a high-frequency signal is fed in by the signal feed-in portion 34 and transmitted to the ground element 32 through the bent short-circuit pin 33, the signal transmission current flows in the same direction through the bent structure 33a and is counteracted, so as to enhance the radiation of energy.

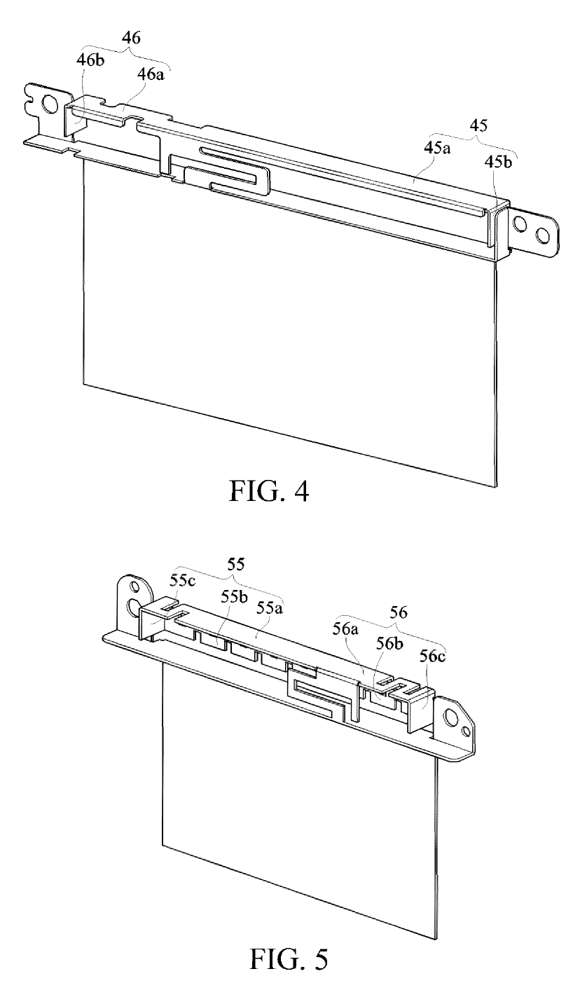

FIG. 4 is a schematic view according to a third embodiment of the present invention. Referring to FIG. 4, the structure of this embodiment is similar to that of the second embodiment, and the difference is as follows. The first radiation portion 45 in the third embodiment includes a flat metal 45a and a rectangular metal plate 45b. The flat metal 45a has one end perpendicularly connected to the rectangular metal plate 45b. The second radiation portion 46 includes a flat metal 46a and a rectangular metal plate 46b. The flat metal 46a has one end with a serpentine structure, and the rectangular metal plate 46b is perpendicularly connected to the serpentine structure.

The third embodiment relates to a large-sized antenna applicable to a wireless wide area network (WWAN), or, of course, other antennae different in size or shape designed based on various network systems or demands.

FIG. 5 is a schematic view according to a fourth embodiment of the present invention. Referring to FIG. 5, the structure of this embodiment is similar to that of the second embodiment, and the difference is as follows. The first radiation portion 55 in the fourth embodiment includes a flat metal 55a, a serpentine metal plate 55b, and a rectangular metal plate 55c. The flat metal 55a has one end with a serpentine structure, and the rectangular metal plate 55c is perpendicularly connected to the serpentine structure. The serpentine metal plate 55b is perpendicularly connected to one side of the rectangular metal plate 55c. The second radiation portion 56 includes a flat metal 56a, a serpentine metal plate 56b, and a rectangular metal plate 56c. The flat metal 56a has one end with a serpentine structure, and the rectangular metal plate 56c is perpendicularly connected to the serpentine structure. The serpentine metal plate 56b is perpendicularly connected to one side of the rectangular metal plate 56c.

The fourth embodiment relates to a small-sized antenna applicable to a WWAN, or, of course, other antennae different in size or shape designed based on various network systems or demands.

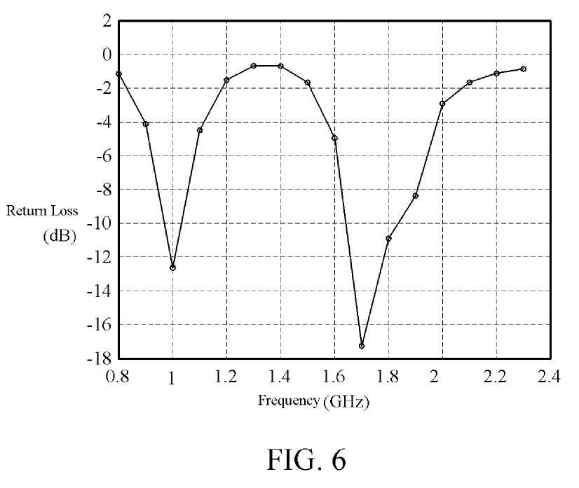

FIG. 6 is a diagram of return-loss simulation according to the second embodiment of the present invention. It can be seen from FIG. 6 that, the return loss measured at a high frequency (from 1710 MHz to 2170 MHz) is smaller than that measured at a low frequency (from 824 MHz to 960 MHz), which indicates that the dual-band inverted-F antenna of the present invention may enhance the energy at a high frequency.

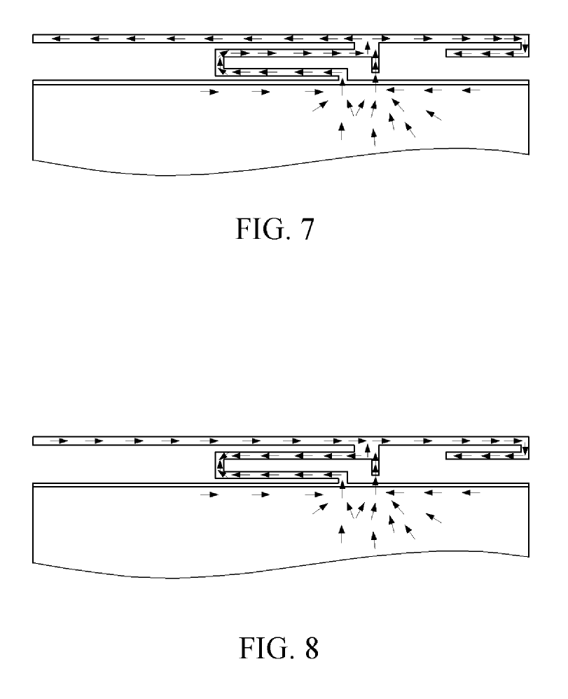

FIG. 7 is a diagram of current simulation at a low frequency according to the second embodiment of the present invention. It can be seen from FIG. 7 that, when the input signal is at a low frequency of 1000 MHz, the current flows in opposite directions through the bent structure, and thus the energy is counteracted, so as to reduce the interference of the bent short-circuit pin on the radiation element of the dual-band inverted-F antenna.

FIG. 8 is a diagram of current simulation at a high frequency according to the second embodiment of the present invention. It can be seen from FIG. 8 that, when the input signal is at a high frequency of 1700 MHz, the current flows in the same direction through the bent structure, thereby enhancing the radiation of energy.

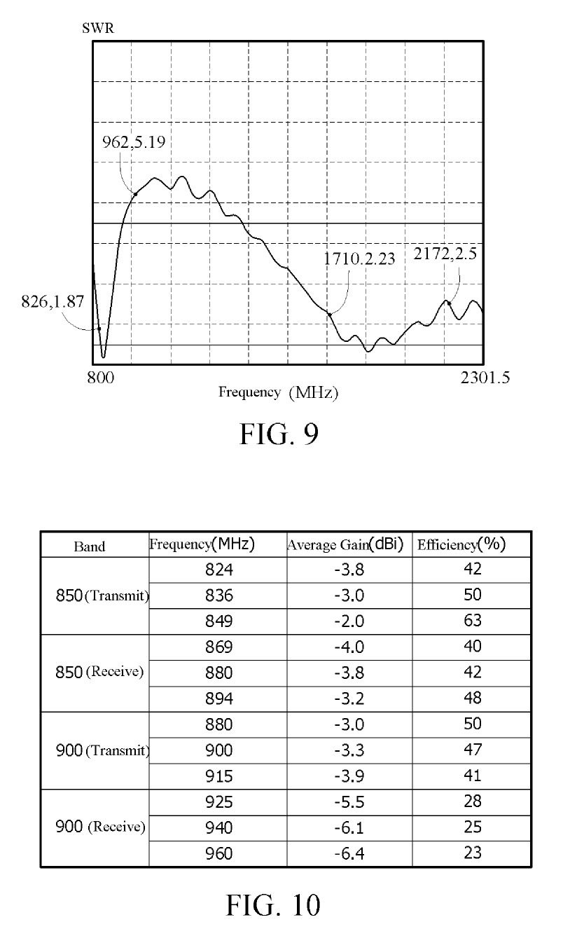

FIG. 9 is a measurement diagram of standing wave ratio (SWR) according to the third embodiment of the present invention. It can be seen from FIG. 9 that, in the third embodiment, the maximum SWR at a low frequency of 824 MHz to 960 MHz is 5.1, and the average SWR at a high frequency of 1710 MHz to 2170 MHz is approximately 2.

FIG. 10 is a table showing average gains and efficiencies of the dual-band inverted-F antenna measured at low frequencies according to the third embodiment of the present invention. It can be seen from FIG. 10 that, at a low frequency of 824 MHz to 960 MHz, the average gain is about −3 dB, and the efficiency is about 50%.

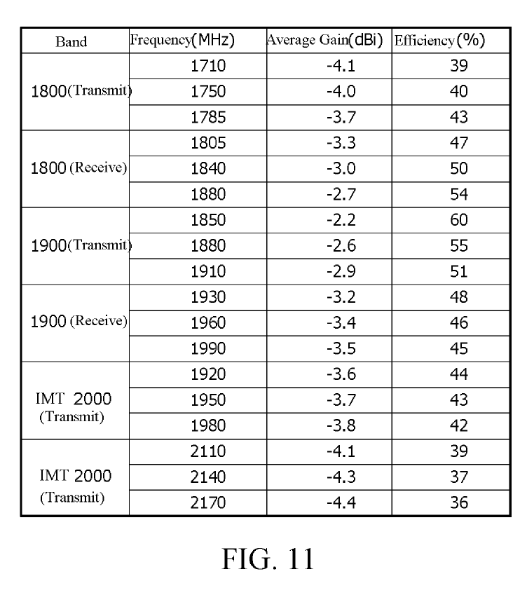

FIG. 11 is a table showing average gains and efficiencies of the dual-band inverted-F antenna measured at high frequencies according to the third embodiment of the present invention. It can be seen from FIG. 11 that, at a high frequency of 1710 MHz to 2170 MHz, the average gain is about −3 dB, and the efficiency is about 50%. Further, it can be seen from FIGS. 10 and 11 that, the dual-band inverted-F antenna in the third embodiment of the present invention is more efficient and has lower energy loss at a high frequency than at a low frequency.

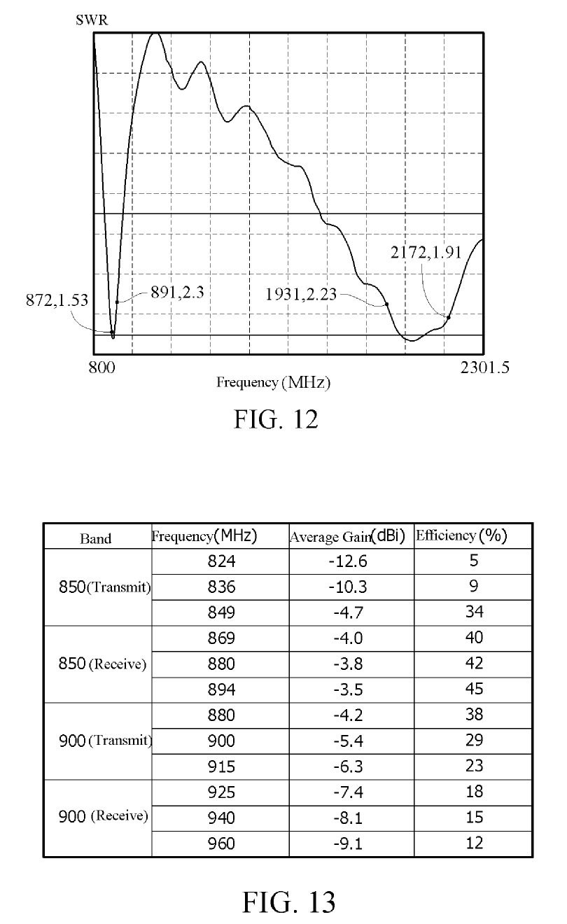

FIG. 12 is a measurement diagram of SWR according to the fourth embodiment of the present invention. It can be seen from FIG. 12 that, in the fourth embodiment, the SWR at a low frequency of 824 MHz to 960 MHz is generally below 2, and the SWR at a high frequency of 1710 MHz to 2170 MHz is generally below 2.

FIG. 13 is a table showing average gains and efficiencies of the dual-band inverted-F antenna measured at low frequencies according to the fourth embodiment of the present invention. It can be seen from FIG. 13 that, at the frequencies close to two ends of the frequency band from 824 MHz to 960 MHz, the energy loss is large, and the efficiency drops below 10%.

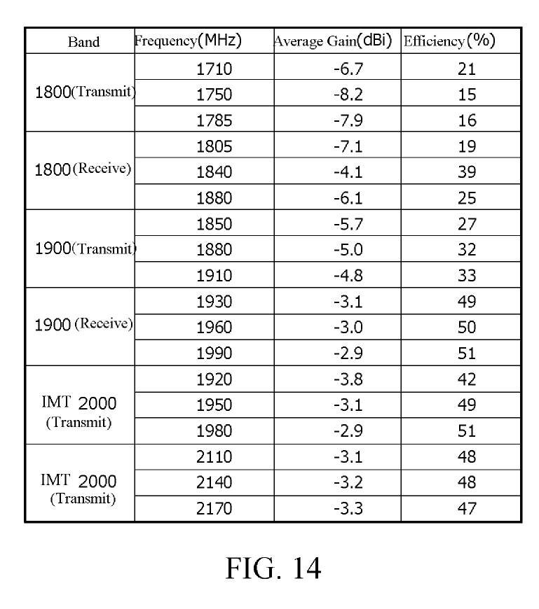

FIG. 14 is a table showing average gains and efficiencies of the dual-band inverted-F antenna measured at high frequencies according to the fourth embodiment of the present invention. It can be seen from FIG. 14 that, at the high frequencies of 1710 MHz to 2170 MHz, for the frequencies above 1930 MHz, the average gain is about −3 dB and the efficiency is about 50%, and for those below 1930 MHz, as the frequency is getting lower, the average gain and efficiency will be worse.

What is claimed is:

1. A dual-band inverted-F antenna, comprising:
a radiation element, having a first radiation portion and a second radiation portion, wherein the first radiation portion is used for wirelessly transmitting/receiving a first band signal, and the second radiation portion is used for wirelessly transmitting/receiving a second band signal;
a ground element, spaced from and facing the radiation element;
a short-circuit pin, located between the radiation element and the ground element, and having two ends perpendicularly connected to the radiation element and the ground element respectively; and
a signal feed-in portion, having one end perpendicularly connected to the radiation element, and the other end extending toward the ground element.

2. The dual-band inverted-F antenna as claimed in claim 1, wherein the short-circuit pin and the signal feed-in portion are connected to the same side of the radiation element.

3. The dual-band inverted-F antenna as claimed in claim 1, wherein a length of the first radiation portion is between one-third wavelength and one-fifth wavelength of the first band signal.

4. The dual-band inverted-F antenna as claimed in claim 1, wherein a length of the second radiation portion is between one-third wavelength and one-fifth wavelength of the second band signal.

5. A dual-band inverted-F antenna, comprising:
a radiation element, having a first radiation portion and a second radiation portion, wherein the first radiation portion is used for wirelessly transmitting/receiving a first band signal, and the second radiation portion is used for wirelessly transmitting/receiving a second band signal;
a ground element, spaced from and facing the radiation element;
a bent short-circuit pin, located between the radiation element and the ground element, having two ends perpendicularly connected to the radiation element and the ground element respectively, and formed with a bent structure at the center; and
a signal feed-in portion, having one end together with the bent short-circuit pin perpendicularly connected to the radiation element, and the other end extending toward the ground element.

6. The dual-band inverted-F antenna as claimed in claim 5, wherein the bent short-circuit pin comprises a first arm, a second arm, and the bent structure; the first arm has one end perpendicularly connected to the radiation element and the other end extending toward the ground element so as to be connected to one end of the bent structure; and the second arm has one end perpendicularly connected to the ground element, and the other end extending toward the radiation element so as to be connected to the other end of the bent structure.

7. The dual-band inverted-F antenna as claimed in claim 5, wherein the bent structure is in a “ [symbol] ” shape or a horseshoe shape.

8. The dual-band inverted-F antenna as claimed in claim 5, wherein the bent structure and the first radiation portion are in the same direction.

9. The dual-band inverted-F antenna as claimed in claim 5, wherein the bent structure and the second radiation portion are in the same direction.

10. The dual-band inverted-F antenna as claimed in claim 5, wherein a length of the first radiation portion is between one-third wavelength and one-fifth wavelength of the first band signal.

11. The dual-band inverted-F antenna as claimed in claim 5, wherein a length of the second radiation portion is between one-third wavelength and one-fifth wavelength of the second band signal.

12. The dual-band inverted-F antenna as claimed in claim 5, wherein the first radiation portion is a flat metal.

13. The dual-band inverted-F antenna as claimed in claim 5, wherein the first radiation portion comprises a flat metal, a serpentine metal plate, and a rectangular metal plate, the flat metal has one end with a serpentine structure, the rectangular metal plate is perpendicularly connected to the serpentine structure, and the serpentine metal plate is perpendicularly connected to one side of the rectangular metal plate.

14. The dual-band inverted-F antenna as claimed in claim 5, wherein the first radiation portion comprises a flat metal and a rectangular metal plate, and the flat metal has one end perpendicularly connected to the rectangular metal plate.

15. The dual-band inverted-F antenna as claimed in claim 5, wherein the second radiation portion is a flat metal.

16. The dual-band inverted-F antenna as claimed in claim 5, wherein the second radiation portion comprises a flat metal, a serpentine metal plate, and a rectangular metal plate, the flat metal has one end with a serpentine structure, the rectangular metal plate is perpendicularly connected to the serpentine structure, and the serpentine metal plate is perpendicularly connected to one side of the rectangular metal plate.

17. The dual-band inverted-F antenna as claimed in claim 5, wherein the second radiation portion comprises a flat metal and a rectangular metal plate, the flat metal has one end with a serpentine structure, and the rectangular metal plate is perpendicularly connected to the serpentine structure.
